(19) United States
(12) Patent Application Publication
(10) Pub. No.: US 2026/0223132 A1
(43) Pub. Date: Jul. 30, 2026

(54) TECHNIQUES FOR DOWNLINK CONTROL CHANNEL REPETITION

(71) Applicant: QUALCOMM Incorporated, San Diego, CA (US)

(72) Inventors: Le LIU, San Jose, CA (US); Alberto RICO ALVARINO, San Diego, CA (US); Xiao Feng WANG, San Diego, CA (US)

(21) Appl. No.: 19/040,713

(22) Filed: Jan. 29, 2025

(51) Int. Cl. H04W 72/232; H04L 1/08; H04L 5/00

(52) U.S. Cl. CPC H04W 72/232; H04L 1/08; H04L 5/0048

(57) ABSTRACT

Methods, systems, and devices for wireless communications are described. A user equipment (UE) may receive configuration information associated with downlink control channel repetition. The configuration information may include a repetition parameter and a monitoring window duration. The UE may receive first downlink control information in a first occasion of a monitoring window with the monitoring window duration based on the configuration information. The first occasion of the monitoring window may be associated with a first synchronization signal block (SSB). The UE may receive second downlink control information that is a repetition of the first downlink control information in a second occasion of the monitoring window based on the configuration information and in accordance with the repetition parameter, where the second occasion of the monitoring window is associated with the first SSB.

### FIELD OF TECHNOLOGY

The following relates to wireless communications, including techniques for downlink control channel repetition.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information associated with downlink control channel repetition, where the configuration information includes a repetition parameter and a monitoring window duration, receiving first downlink control information in a first occasion of a monitoring window with the monitoring window duration based on the configuration information, where the first occasion of the monitoring window is associated with a first synchronization signal block, and receiving second downlink control information that is a repetition of the first downlink control information in a second occasion of the monitoring window based on the configuration information and in accordance with the repetition parameter, where the second occasion of the monitoring window is associated with the first synchronization signal block.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive configuration information associated with downlink control channel repetition, where the configuration information includes a repetition parameter and a monitoring window duration, receive first downlink control information in a first occasion of a monitoring window with the monitoring window duration based on the configuration information, where the first occasion of the monitoring window is associated with a first synchronization signal block, and receive second downlink control information that is a repetition of the first downlink control information in a second occasion of the monitoring window based on the configuration information and in accordance with the repetition parameter, where the second occasion of the monitoring window is associated with the first synchronization signal block.

Another UE for wireless communications is described. The UE may include means for receiving configuration information associated with downlink control channel repetition, where the configuration information includes a repetition parameter and a monitoring window duration, means for receiving first downlink control information in a first occasion of a monitoring window with the monitoring window duration based on the configuration information, where the first occasion of the monitoring window is associated with a first synchronization signal block, and means for receiving second downlink control information that is a repetition of the first downlink control information in a second occasion of the monitoring window based on the configuration information and in accordance with the repetition parameter, where the second occasion of the monitoring window is associated with the first synchronization signal block.

A non-transitory computer-readable medium storing code for wireless communications is described. The code may include instructions executable by one or more processors (e.g., directly, indirectly, after pre-processing, without pre-processing) to receive configuration information associated with downlink control channel repetition, where the configuration information includes a repetition parameter and a monitoring window duration, receive first downlink control information in a first occasion of a monitoring window with the monitoring window duration based on the configuration information, where the first occasion of the monitoring window is associated with a first synchronization signal block, and receive second downlink control information that is a repetition of the first downlink control information in a second occasion of the monitoring window based on the configuration information and in accordance with the repetition parameter, where the second occasion of the monitoring window is associated with the first synchronization signal block.

In some examples of the method, UEs, and non-transitory computer-readable medium described herein, the downlink control channel repetition may be inter-slot repetition with an occasion corresponding to a slot, intra-slot repetition with an occasion corresponding to a sub-slot, or a combination of the inter-slot repetition and the intra-slot repetition.

In some examples of the method, UEs, and non-transitory computer-readable medium described herein, a set of multiple occasions, including at least the first occasion and the second occasion, associated with the first synchronization signal block and corresponding to the repetition parameter may be contiguous in time in the monitoring window.

In some examples of the method, UEs, and non-transitory computer-readable medium described herein, the first occasion and the second occasion may be non-contiguous in time based on a quantity of actually transmitted synchronization signals blocks.

In some examples of the method, UEs, and non-transitory computer-readable medium described herein, the monitoring window duration may be based on the repetition parameter and a second monitoring window duration that may be not associated with the downlink control channel repetition.

In some examples of the method, UEs, and non-transitory computer-readable medium described herein, the configuration information includes a first quantity of downlink control channel repetitions in occasions that may be contiguous in time and a second quantity of downlink control channel repetitions in the monitoring window duration.

In some examples of the method, UEs, and non-transitory computer-readable medium described herein, the configuration information includes a pattern for the downlink control channel repetition including contiguous downlink control channel repetition or non-contiguous downlink control channel repetition.

Some examples of the method, UEs, and non-transitory computer-readable medium described herein may further include operations, features, means, or instructions for estimating a downlink control channel for the first downlink control information or the second downlink control information, or both, based on a demodulation reference signal bundling for the first occasion and the second occasion.

In some examples of the method, UEs, and non-transitory computer-readable medium described herein, the configuration information includes a threshold duration associated with the demodulation reference signal bundling and a delay between the first occasion and the second occasion satisfies the threshold duration.

In some examples of the method, UEs, and non-transitory computer-readable medium described herein, the configuration information includes a threshold frequency gap associated with the demodulation reference signal bundling and a frequency gap between the first occasion and the second occasion satisfies the threshold frequency gap.

In some examples of the method, UEs, and non-transitory computer-readable medium described herein, the configuration information includes an indication that demodulation reference signal bundling may be enabled for the downlink control channel repetition.

Some examples of the method, UEs, and non-transitory computer-readable medium described herein may further include operations, features, means, or instructions for performing a first blind decoding procedure to obtain the first downlink control information based on first control channel candidates of the first occasion having a timing configuration and performing a second blind decoding procedure to obtain the second downlink control information based on second control channel candidates of the second occasion having the timing configuration.

In some examples of the method, UEs, and non-transitory computer-readable medium described herein, the first blind decoding procedure and the second blind decoding procedure may be performed based on an aggregation level that may be above a threshold in accordance with the downlink control channel repetition.

In some examples of the method, UEs, and non-transitory computer-readable medium described herein, the first downlink control information and the second downlink control information include a same slot offset value, a redundancy value associated with a first physical downlink shared channel, respective repetition parameters, or any combination thereof.

In some examples of the method, UEs, and non-transitory computer-readable medium described herein, the UE may be operating in an inactive mode or an idle mode and the downlink control channel repetition may be associated with the inactive mode or the idle mode, or both.

In some examples of the method, UEs, and non-transitory computer-readable medium described herein, the first downlink control information and the second downlink control information include scheduling information for remaining minimum system information, paging information, multi-broadcast system information, paging early indication information, or any combination thereof.

In some examples of the method, UEs, and non-transitory computer-readable medium described herein, the UE may be operating in a non-terrestrial network or using a radio frequency spectrum band of the non-terrestrial network.

In some examples of the method, UEs, and non-transitory computer-readable medium described herein, the first downlink control information and the second downlink control information may be received via broadcast signaling, multi-cast signaling, or multi-broadcast signaling, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for downlink control channel repetition in accordance with one or more aspects of the present disclosure.

FIG. 2 shows an example of a wireless communications system that supports techniques for downlink control channel repetition in accordance with one or more aspects of the present disclosure.

FIG. 3 shows an example of an inter-slot repetition configuration that supports techniques for downlink control channel repetition in accordance with one or more aspects of the present disclosure.

FIG. 4 shows an example of an inter-slot repetition configuration that supports techniques for downlink control channel repetition in accordance with one or more aspects of the present disclosure.

FIG. 5 shows an example of an inter-slot repetition configuration that supports techniques for downlink control channel repetition in accordance with one or more aspects of the present disclosure.

FIG. 6 shows an example of a process flow that supports techniques for downlink control channel repetition in accordance with one or more aspects of the present disclosure.

FIGS. 7 and 8 show block diagrams of devices that support techniques for downlink control channel repetition in accordance with one or more aspects of the present disclosure.

FIG. 9 shows a block diagram of a communications manager that supports techniques for downlink control channel repetition in accordance with one or more aspects of the present disclosure.

FIG. 10 shows a diagram of a system including a device that supports techniques for downlink control channel repetition in accordance with one or more aspects of the present disclosure.

FIGS. 11 and 12 show flowcharts illustrating methods that support techniques for downlink control channel repetition in accordance with one or more aspects of the present disclosure.

### DETAILED DESCRIPTION

A wireless communications system may support downlink coverage enhancement, such as physical downlink control channel (PDCCH) repetition. With PDCCH repetition, a network entity may transmit repetitions of the same downlink control information to a user equipment (UE) to increase reliability and improve decoding performance at the UE. In some wireless communications systems, the network entity may transmit the PDCCH repetitions to the UE within linked search space sets of a same slot. However, in these systems, the linked search space sets are limited to intra-slot PDCCH repetition of a specific search space set type, and repetition may only be supported while the UE is operating in a connected mode.

A wireless communications system described herein supports techniques for downlink control channel repetition, including intra-slot and/or inter-slot control channel repetition, PDCCH repetition for idle and inactive UEs, and PDCCH repetition for multiple different types of search space sets, including search spaces other than the search spaces which can only be configured for a UE in connected mode. For example, a network entity may configure a UE for intra-slot PDCCH repetition, and the network entity may indicate a pair of linked common search space set for the intra-slot PDCCH repetition to the UE, associated with the same synchronization signal block (SSB). Alternatively, a network entity may configure a UE for intra-slot PDCCH repetition, and the network entity may indicate one search space set with additional span of PDCCH symbol(s) in a slot for the intra-slot PDCCH repetition to the UE, associated with the same synchronization signal block (SSB). For example, a network entity may configure a UE for inter-slot PDCCH repetition, and the network entity may indicate a repetition parameter for the inter-slot PDCCH repetition to the UE. The repetition parameter may indicate a quantity of PDCCH repetitions associated with each synchronization signal block (SSB) within a scheduling window for PDCCH with repetition. In some examples, inter-slot PDCCH repetition may be configured according to a first pattern, where multiple contiguous slots include repetitions of PDCCH and are associated with a same SSB. In some examples, inter-slot PDCCH repetition may be configured according to a second pattern, where PDCCH repetitions for a same SSB are non-contiguous, and PDCCH monitoring occasions cycle through SSBs (e.g., actually transmitted SSBs) before repeating. In some examples, inter-slot PDCCH repetition may be configured according to a third pattern, where a first quantity of PDCCH repetitions associated with a same SSB are transmitted in contiguous slots a second quantity of times, cycling through the SSBs the second quantity of times per PDCCH scheduling window.

The wireless communications system may support DMRS bundling for intra-slot PDCCH repetition or inter-slot PDCCH repetition, or both. For DMRS bundling for intra-slot PDCCH repetition, if a common search space is configured with a pair of linked search space sets, a UE may determine the search space sets are linked to PDCCH repetition in a same slot and determine or be configured to enable DMRS bundling for the linked search space sets. If the UE is configured with one search space set, the search space set may be configured with an additional PDCCH span within the slot of the PDCCH monitoring occasion, and the UE may determine or be configured to enable DMRS bundling. For inter-slot PDCCH repetition, a network entity may configure a UE to assume DMRS bundling for channel estimation for PDCCH combining. In some examples, the DMRS bundling techniques may be based on one or more thresholds. For example, if the PDCCH repetitions are within a threshold time difference or frequency difference, the UE may use DMRS bundling to decode the PDCCH repetitions. Some additional techniques for blind decoding based on intra-slot and/or inter-slot PDCCH repetition and downlink control information signaling are described herein.

Aspects of the disclosure are initially described in the context of wireless communications systems. Aspects of the disclosure are further illustrated by and described with reference to inter-slot repetition configurations, a process flow, apparatus diagrams, system diagrams, and flowcharts that relate to techniques for downlink control channel repetition.

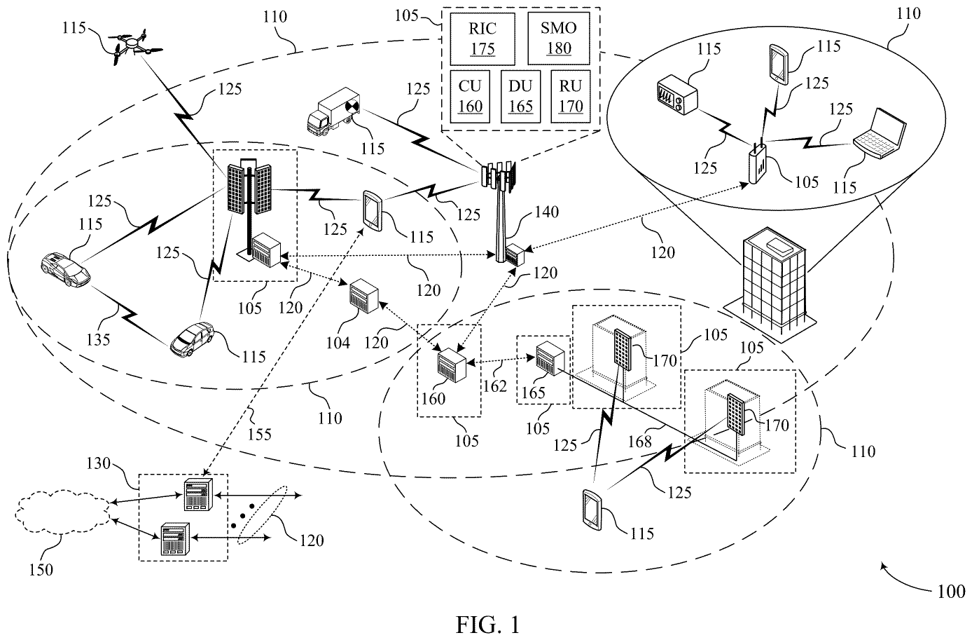

FIG. 1 shows an example of a wireless communications system 100 that supports techniques for downlink control channel repetition in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for downlink control channel repetition as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support techniques for PDCCH repetition. In some wireless communications systems, inter-slot PDCCH repetition is not supported. Some wireless communications systems may support intra-slot PDCCH repetition under certain limitations. For example, some wireless communications systems may support intra-slot PDCCH repetitions for UEs 115 operating in an RRC connected mode and only for a user-specific search space (USS) or certain common search spaces (CSSs), such as Type-3 CSS. PDCCH candidates from two linked search space sets, based on having a same value of a search space linking identifier in a search space configuration, may be combined to improve downlink coverage. Blind detection may not be changed for intra-slot PDCCH repetition assuming a same DCI format and/or same quantity of PDCCH candidates. For other CSS (e.g., other than Type-3 CSS), these other wireless communications systems may not support PDCCH repetition.

A UE 115 operating in an idle mode or an inactive mode may monitor for PDCCH signaling according to a scheduling window. The scheduling window for PDCCH monitoring may be configured for remaining minimum system information (RMSI), paging information, multi-broadcast system (MBS) information, paging early indication (PEI) information, or any combination thereof. For RMSI, the scheduling window may be configured by a parameter (e.g., si-WindowLength) in terms of slot number. For paging, the scheduling window may be determined by a first parameter indicating a quantity of PDCCH monitoring occasions per paging occasion (e.g., firstPDCCH-MonitoringOccasionofPO) and a second parameter indicating a quantity of PDCCH monitoring occasions per SSB in the paging occasion (e.g., nrofPDCCH-MonitoringOccasionsPerSSB-InPO). For MBS multi-cast control channel (MCCH), the scheduling window may be configured by a first parameter indicating a window starting slow (e.g., mcch-WindowStartSlot) and a second parameter indicating a window duration (e.g., mcch-WindowDuration). For MBS multicast traffic channel (MTCH), the search window may be configured by a parameter indicating an SSB to mapping window cycle offset (e.g., mtch-SSB-MappingWindowCycleOffset).

In scheduling window, PDCCH monitoring occasions may be associated with SSBs. For example, a [x×N+K]th PDCCH monitoring occasion in a scheduling window may correspond to the Kth transmitted SSB, where x ranges from 0 to X-1, and K ranges from 1 to N. N is a quantity of actually transmitted SSBs (e.g., according to a parameter, ssb-PositionsInBurst, indicated by system information block 1 (SIB 1)), and X corresponds to the ceiling of the quantity of PDCCH monitoring occasions in the configured scheduling window divided by the quantity of actually transmitted SSBs.

In some wireless communications systems, a UE 115 may monitor a PDCCH monitoring occasion for a search space set, such as search space set 0(SS0), indicated by a master information block (MIB). In some systems, the UE 115 may monitor PDCCH in the Type0 PDCCH CSS (e.g., SS0) over up to two consecutive slots associated with the same SSB if the SSB and CORESET0 multiplexing pattern 1 is used. In other systems, the UE 115 may monitor PDCCH in the Type0 PDCCH CSS (e.g., SS0) over one slot associated per SSB and no consecutive slots associated with the same SSB if the SSB and CORESET0 multiplexing pattern 2 or 3 is used. If a SS set other than SS0 is configured (e.g., by SIB1), the scheduling window as described herein may be used for PDCCH monitoring.

The wireless communications system 100 may support techniques for PDCCH repetition, such as intra-slot repetition or inter-slot repetition. For example, the wireless communications system 100 may support intra-slot or inter-slot PDCCH repetition for multiple common search spaces, including SS0 and SS other than SS0 if configured. In some examples, a UE 115 operating in an idle mode or an inactive mode may monitor for PDCCH based on an intra-slot or and/or inter-slot PDCCH repetition configurations and/or pre-configurations.

For example, a network entity 105 may configures a UE 115 for inter-slot PDCCH repetition, and the network entity 105 may indicate a repetition parameter for the inter-slot PDCCH repetition to the UE 115. The repetition parameter may indicate a quantity of PDCCH repetitions associated with each SSB within a scheduling window for PDCCH with repetition. In some examples, inter-slot PDCCH repetition may be configured according to a first pattern, where multiple contiguous slots include repetitions of PDCCH and are associated with a same SSB. In some examples, inter-slot PDCCH repetition may be configured according to a second pattern, where PDCCH repetitions for a same SSB are non-contiguous, and PDCCH monitoring occasions cycle through SSBs (e.g., actually transmitted SSBs configured by SIB1) before repeating. In some examples, inter-slot PDCCH repetition may be configured according to a third pattern, where a first quantity of PDCCH repetitions associated with a same SSB are transmitted in contiguous slots a second quantity of times, cycling through the SSBs the second quantity of times per PDCCH scheduling window.

The wireless communications system 100 may support DMRS bundling for intra-slot PDCCH repetition or inter-slot PDCCH repetition, or both. For DMRS bundling for intra-slot PDCCH repetition, if a common search space is configured with a pair of linked search space sets, a UE 115 may determine the search space sets are linked to PDCCH repetition in a same slot and determine or be configured to enable DMRS bundling for the linked search space sets. If the UE 115 is configured with one search space set, the search space set may be configured with an additional PDCCH span within the slot of the PDCCH monitoring occasions, and the UE 115 may determine or be configured to enable DMRS bundling.

For inter-slot PDCCH repetition, a network entity may configure a UE 115 to assume DMRS bundling for channel estimation for PDCCH combining. In some examples, the DMRS bundling techniques may be based on one or more thresholds. For example, if the PDCCH repetitions are within a threshold time difference or frequency difference, the UE 115 may use DMRS bundling to decode the PDCCH repetitions. Some additional techniques for blind decoding based on intra-slot and inter-slot PDCCH repetition and downlink control information signaling are described herein.

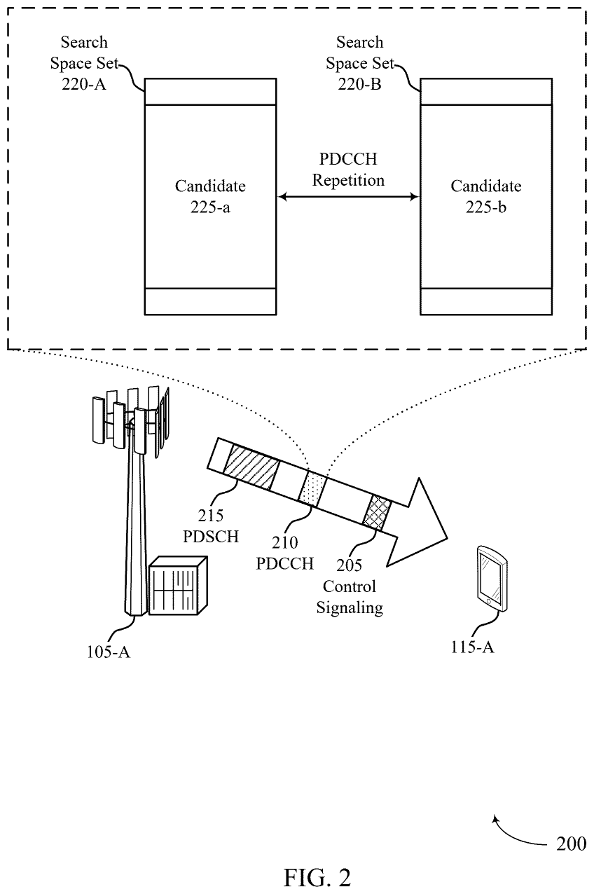

FIG. 2 shows an example of a wireless communications system 200 that supports techniques for downlink control channel repetition in accordance with one or more aspects of the present disclosure. The wireless communications system 200 may implement aspects of a wireless communications system 100. For example, the wireless communications system 200 may include a UE 115-a and a network entity 105-a, which may be respective examples of a UE 115 and a network entity 105 as described herein.

The network entity 105-a may transmit control signaling 205 to configure the UE 115-a for PDCCH repetition. In some examples, the network entity 105-a may configure the UE 115-a for inter-slot PDCCH repetition. Additionally, or alternatively, the network entity 105-a may configure the UE 115-a for intra-slot PDCCH repetition. In some examples, RRC signaling, system information (e.g., a SIB or SIB1), or a MIB may be an example of the control signaling 205. In some examples, the PDCCH repetition may be preconfigured in a radio frequency spectrum band or in a private network.

When PDCCH repetition is configured, the network entity 105-a may transmit multiple PDCCH 210 to the UE 115-a. In some examples, the PDCCH 210 may schedule the UE 115-a for shared channel communication, such to receive data signaling via a physical downlink shared channel (PDSCH) 215 or to transmit data signaling via a physical uplink shared channel (PUSCH).

The network entity 105-a may transmit multiple repetitions of downlink control information to the UE 115-a according to PDCCH repetition. For example, the UE 115-a may search a search space set 220-a to decode a PDCCH candidate 225-a and obtain first downlink control information. The UE 115-a may search a search space set 220-b to decode a PDCCH candidate 225-b and obtain second downlink control information. According to PDCCH repetition, the first downlink control information and second downlink control information may include the same downlink control information.

In some examples, the network entity 105-a may configure the UE 115-a for inter-slot PDCCH repetition. For example, the search space set 220-a may be in a first slot, and the search space set 220-b may be in a second slot that is different from the first slot. The control signaling 205 may indicate a repetition parameter, R, for the inter-slot PDCCH repetition. The repetition parameter may indicate a quantity of PDCCH repetitions associated with an SSB. In some examples, the repetition parameter may correspond to the quantity of PDCCH repetitions associated with an SSB within a scheduling window or the quantity of PDCCH repetitions associated with an SSB within a sub-window of the scheduling window, or both.

In some examples, for inter-slot PDCCH repetition, the network entity 105-a may transmit PDCCH repetitions using beamformed communications based on SSBs. For example, the network entity 105-a may transmit multiple PDCCH repetitions that are associated with a first SSB using a same beam direction as the first SSB. The network entity 105-a may transmit PDCCH repetitions in beam directions that correspond to actually transmitted SSBs (e.g., indicated by SIB1). For example, the network entity 105-a may support transmission of SSBs in multiple directions, but the network entity 105-a may actually transmit SSBs in a subset of the multiple directions (e.g., and not all possible directions). In some examples, the network entity 105-a may transmit PDCCH repetitions in beamforming directions that correspond to actually transmitted SSBs.

PDCCH repetition may be configured according to a repetition pattern. In some examples, the network entity 105-a may configure the UE 115-a with the repetition pattern. In some other examples, a repetition pattern may be statically configured for the wireless communications system 200. The UE 115-a may monitor for PDCCH (e.g., for repetitions of PDCCH) according to the repetition pattern.

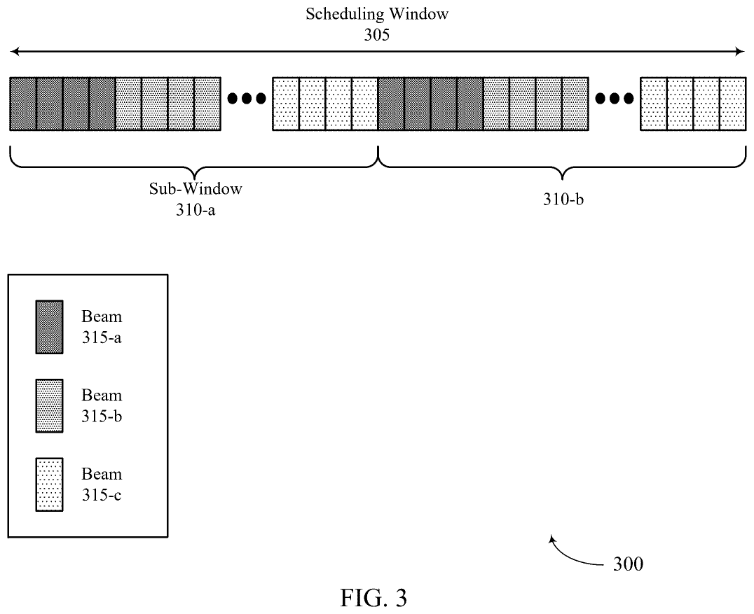

In some examples, the inter-slot PDCCH repetition may be configured according to a first repetition pattern. The first repetition pattern may include contiguous PDCCH repetition corresponding to an associated SSB. An example of contiguous PDCCH repetition is described in more detail with reference to FIG. 3.

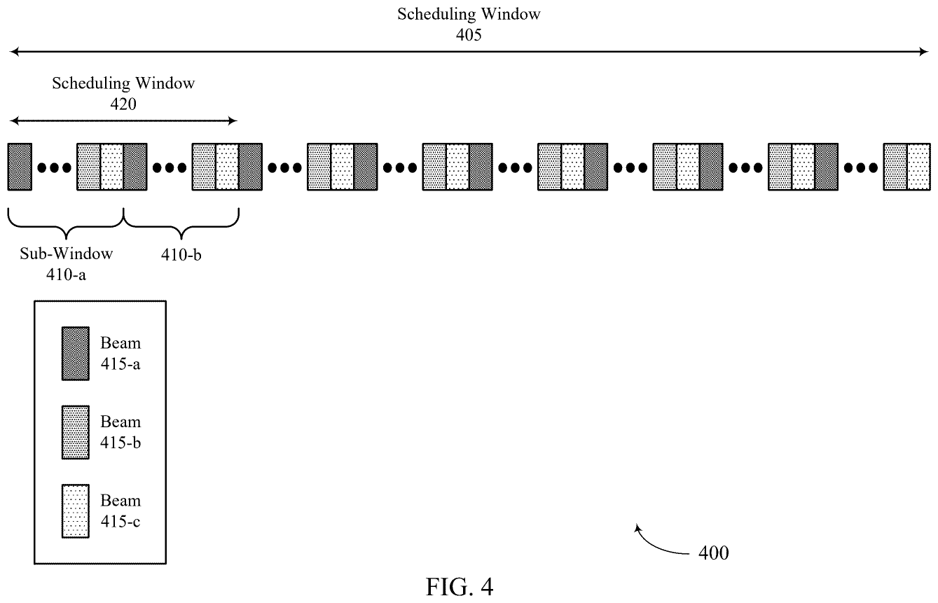

In some examples, the inter-slot PDCCH repetition may be configured according to a second repetition pattern. The second repetition pattern may include non-contiguous PDCCH repetition corresponding to an associated SSB. An example of non-contiguous PDCCH repetition is described in more detail with reference to FIG. 4.

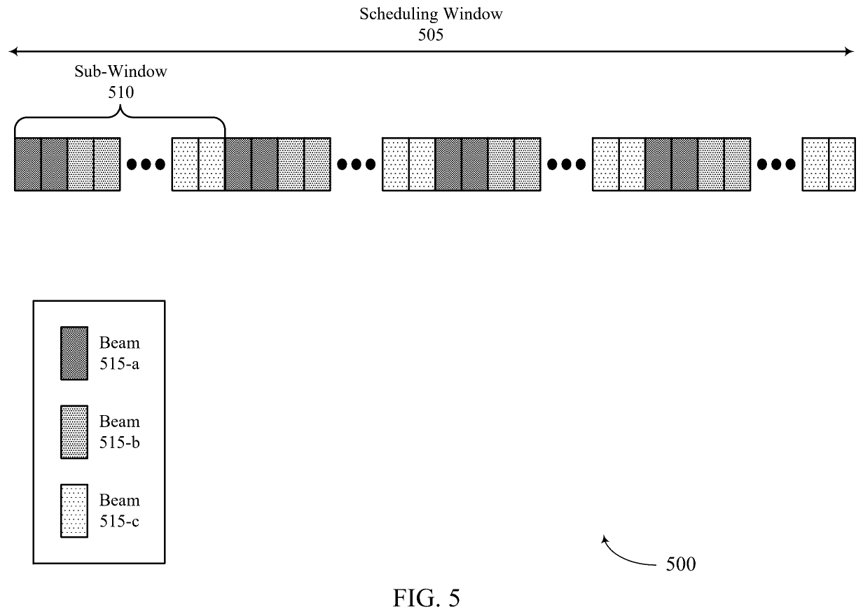

In some examples, the inter-slot PDCCH repetition may be configured according to a third repetition pattern. The third repetition pattern may include contiguous PDCCH repetition and non-contiguous PDCCH repetition corresponding to one SSB. An example of non-contiguous PDCCH repetition is described in more detail with reference to FIG. 5.

In some examples, the wireless communications system 200 may support DMRS bundling for PDCCH repetition. In some wireless communications systems, a USS or Type 3 CSS may be configured with a pair of linked search space sets. The UE 115 may assume these search spaces are linked to PDCCH repetition in the same slot, but the UE 115 may not assume DMRS bundling for the linked search space sets, as the search space sets may use different TCI states for TRP beamforming. For example, a first search space set may be associated with a first control resource set and a first TRP using a first TCI state, and a second search space set may be associated with a second control resource set and a second TRP using a second TCI state. Therefore, the UE 115 of these systems may not be able to use DMRS bundling, as PDCCH signaling may be transmitted using different TCI states and beamforming configurations.

The network entity 105-a may configure the UE 115-a to enable DMRS bundling for channel estimation when the UE 115-a is configured for intra-slot PDCCH repetitions. For example, the UE 115-a may be configured for intra-slot PDCCH repetition for a search space set (e.g., for a Type 0, Type 0A, Type 0B, Type 1A, Type 2, or Type 2A common search space, or a common search space set other than a Type 3 common search space set). For a CSS with intra-slot PDCCH repetition, the network entity 105-a may configure whether the UE 115-a may assume DMRS bundling for channel estimation for PDCCH combining, which may improve time diversity. In some examples, if a CSS is configured with a pair of linked search space sets (e.g., based on the search space sets being configured with a same search space linking identifier), the UE 115-a may determine (e.g., assume) that these search space sets are linked to PDCCH repetition in the same slot. The UE 115-a may be configured (e.g., preconfigured or configured by the network entity 105-a) on whether DMRS bundling is enabled for the linked search space set or not. For example, the UE 115-a may determine (e.g., assume) DMRS bundling is enabled for the linked search space sets if the linked search space sets are associated with a same TCI state, same SSB index, same antenna port, or any combination thereof. In some examples, the UE 115-a may determine (e.g., assume) DMRS bundling is enabled if the search space sets are associated with a same control resource set using the same frequency resources and same TCI state or associated with a same SSB index.

For example, the search space set 220-a and the search space set 220-b may be different, but may be linked search space sets within a slot. The search space set 220-a may be associated with a first control resource set and a first TCI state or a first SSB index, and the search space set 220-b may be associated with the first control resource set and the first TCI state or the first SSB index. Based on the search space set 220-a and the search space set 220-a being associated with a same control resource set and TCI state, the UE 115-a may perform channel estimation for the PDCCH candidate 225-a and the PDCCH candidate 225-b based on DMRS bundling for the PDCCH candidate 225-a and the PDCCH candidate 225-b.

In some examples, the network entity 105-a may configure the UE 115-a for intra-slot PDCCH repetition with one search space set. The network entity 105-a may configure the search space set with an additional PDCCH span within the same slot of the PDCCH monitoring occasion. The UE 115-a may determine (e.g., assume) whether DMRS bundling is enabled based on a time offset or frequency offset, or both, between the PDCCH spans or PDCCH candidates, or both.

For example, the search space set 220-a may correspond to a first PDCCH span of a first search space set in a slot, and the search space set 220-b may correspond to a second PDCCH span of the first search space set in the slot. A time offset between the first PDCCH span and the second PDCCH span or a frequency offset between the first PDCCH span and the second PDCCH span, or both, may satisfy a threshold, and the UE 115-a may determine DMRS bundling is enabled for decoding the PDCCH candidate 225-a and the PDCCH candidate 225-b. For example, a time or frequency offset of the second PDCCH span may be within a threshold difference from a first symbol or resource block of the first PDCCH span, and the UE 115-a may use DRMS bundling to perform channel estimation.

In some examples, the wireless communications system 200 may support DMRS bundling for inter-slot PDCCH repetitions. The network entity 105-a may configure (e.g., via the control signaling 205) whether the UE 115-a may assume same transmission scheme for PDCCH repetitions and can use the DMRS bundling for channel estimation for PDCCH combining. With beam sweeping, PDCCH may be quasi co-located with an associated SSB. To enable DMRS bundling for channel estimation, the network entity 105-a may use a same beam transmission with coherent transmission for PDCCH repetitions. The network entity 105-a may indicate whether, or how long, the UE 115-a may assume DMRS bundling for channel estimation. For example, the network entity 105-a may indicate whether DMRS bundling is enabled or disabled. The network entity 105-a may indicate a quantity of slots for DMRS bundling, for example via a MIB or SIB1. In some examples, DMRS bundling may be enabled for certain radio frequency spectrum bands. For example, DMRS bundling may be enabled for a non-terrestrial network (NTN) radio frequency spectrum band with PDCCH inter-slot repetition. Additionally, or alternatively, DMRS bundling may be configured for different repetition patterns. For example, DMRS bundling may be enabled for a first repetition pattern (e.g., described in more detail with reference to FIG. 3) or a third repetition pattern (e.g., described in more detail with reference to FIG. 5), which may include PDCCH repetition across contiguous slots.

In some examples, the UE 115-a may be configured with a threshold quantity of inter-slot PRCCH repetitions. For example, the threshold (e.g., maximum) inter-slot PDCCH repetition quantity, Rmax, may be configured via SIB or PBCH (e.g., a MIB). The UE 115-a may perform blind detection of PDCCH repetitions based on the threshold inter-slot PDCCH repetition quantity. In some cases, with PDCCH repetition, a quantity of PDCCH candidates for blind detection may be increased. With inter-slot PDCCH repetitions, the PDCCH candidates for blind detection may be defined as starting in different slots or as starting in a same slot. For some search spaces, such as CSS used for broadcast signals (e.g., Type 0, Type 0A, Type 2, Type 2A common search spaces), configuring PDCCH candidates for blind detection to start in the same slot may correspond to less PDCCH blind detection monitoring for a UE 115 operating in an RRC idle or RRC inactive state.

In some examples, the PDCCH candidates for different CCE aggregation levels may be reduced. In some wireless communications systems, an aggregation level of 4, 8, or 16 may be assumed for Type 0, Type 0A, Type 2, and Type 2A common search spaces when a UE 115 monitors for SIB1, SIB, paging signaling, and PEI signaling, respectively. If PDCCH repetition is configured, the CCE aggregation level may be reduced based on PDCCH repetition configurations. For example, the UE 115-a may perform blind decoding based on an aggregation level of 8 or higher if PDCCH inter-slot repetition is configured. Additionally, or alternatively, the UE 115-a may perform blind decoding based on an equivalent of an aggregation level of 8 or higher if PDCCH intra-slot repetition is configured, a slot may include two candidates associated with an aggregation level of four or higher.

In some examples, downlink control information transmitted via PDCCH repetition may include information that enables PDCCH combining. For example, for a UE 115 that supports inter-slot repetition, such as the UE 115-a, common downlink control information contents may enable PDCCH combining. In some examples, the network entity 105-a may indicate a same frequency domain resource allocation (FDRA), time domain resource allocation (TDRA), virtual resource block (VRB)-to-physical resource block (PRB) mapping, modulation and coding scheme (MCS), or any combination thereof, via two or more downlink control information. In some examples, downlink control information transmitted via PDCCH repetition may include a same slot offset value, or k0 value. In some examples, downlink control information transmitted via PDCCH repetition may include a same redundancy version for PDSCH. For example, the RV of the starting slot of the scheduled PDSCH (e.g., the PDSCH 215), and other RVs may be based on a preconfigured recursive RV order (e.g., RV0, RV2, RV1, RV3) for PDSCH repetitions if configured. In some examples, downlink control information transmitted via PDCCH repetition may indicate a PDCCH repetition number. UEs 115 which do not support PDCCH repetition may detect a last PDCCH repetition to find a starting slot of the scheduled PDSCH.

For example, first downlink control information decoded from the PDCCH candidate 225-a and second downlink control information decoded from the PDCCH candidate 225-b may include one or more common fields. For example, the first downlink control information and the second downlink control information may indicate a same slot offset, k0, value, a same RV value, a same FDRA, a same TDRA, a same VRB-to-PRB mapping, a same MCS, or any combination thereof.

FIG. 3 shows an example of an inter-slot repetition configuration 300 that supports techniques for downlink control channel repetition in accordance with one or more aspects of the present disclosure. The inter-slot repetition configuration 300 may implement aspects of a wireless communications system 100 and a wireless communications system 200.

A network entity 105 may configure a UE 115 for inter-slot PDCCH repetition. For example, the network entity 105 may transmit control signaling that configures the UE 115 for inter-slot PDCCH repetition. The control signaling may include one or more parameters for inter-slot PDCCH repetition, such as a repetition parameter or a repetition factor, R. The UE 115 may monitor for inter-slot PDCCH repetition in a scheduling window 305 according to a PDCCH monitoring pattern based on a configuration for the inter-slot PDCCH repetition. The scheduling window 305 may include one or more sub-windows 310 based on a quantity of PDCCH monitoring occasions in the scheduling window 305, a quantity of actually transmitted SSBs (e.g., N), and the repetition parameter. For example, the scheduling window 305 may include a sub-window 310-a and a sub-window 310-b. PDCCH monitoring occasions corresponding to the beams 315 may cycle through each sub-window 310 and may repeat across sub-windows 310. The inter-slot repetition configuration 300 shows an example of a first repetition pattern, including contiguous PDCCH repetition corresponding to associated SSBs.

In the example of FIG. 3, the network entity 105 may configure a repetition parameter of four, indicating four PDCCH repetitions associated with each SSB (e.g., each beam 315) per sub-window 310. In other examples, the network entity 105 may configure a different value for the repetition parameter. For the first repetition pattern, the UE 115 may monitor each [x×R×N+(K−1)×R+r]th PDCCH monitoring occasion for PDCCH repetitions, with x ranging from 0 to X-1, K ranging from 1 to N, and r ranging from 1 to R.

For example, in sub-window 310-a, PDCCH associated with beam 315-a may be transmitted across a first four contiguous slots. PDCCH associated with beam 315-b may be transmitted across a next four contiguous slots in the sub-window 310-a PDCCH associated with different beams 315 may be cycled through in the sub-window 310-a until the network entity 105 transmits PDCCH associated with an Nth beam (e.g., beam 315-c) in a last four contiguous slots of the sub-window 310-a. The network entity 105 may transmit R repetitions of PDCCH in contiguous slots for each actually transmitted SSB until the network entity 105 transmits R repetitions of PDCCH in contiguous slots for an Nth SSB, corresponding to beam 315-c. After the network entity 105 cycles through transmitting PDCCH R times in contiguous slots for each actually transmitted SSB, the network entity 105 may transmit PDCCH associated with beam 315-a in a first four contiguous slots of sub-window 310-b.

A UE 115 may monitor for PDCCH based on a detected SSB. For example, the UE 115 may detect an SSB corresponding to beam 315-b, and the UE 115 may monitor for repetitions of PDCCH in PDCCH monitoring occasions that correspond to beam 315-b. In some examples, RRC signaling, system information (e.g., an SIB), a MIB, or any combination thereof, may indicate the inter-slot PDCCH repetition configuration. The UE 115 may monitor PDCCH monitoring occasions for the PDCCH repetitions based on the inter-slot PDCCH repetition configuration.

In some examples, the first repetition pattern may support DMRS bundling. For example, a UE 115 may use DMRS bundling for channel estimation or to combine PDCCH repetitions associated with a same beam 315 in a sub-window 310. For example, the network entity 105 may transmit the PDCCH repetitions in the sub-window 310 using a same beam and with coherent transmission, and the UE 115 may determine (e.g., assume) DMRS bundling is enabled for channel estimation.

FIG. 4 shows an example of an inter-slot repetition configuration 400 that supports techniques for downlink control channel repetition in accordance with one or more aspects of the present disclosure. The inter-slot repetition configuration 400 may implement aspects of a wireless communications system 100 and a wireless communications system 200.

A network entity 105 may configure a UE 115 for inter-slot PDCCH repetition. For example, the network entity 105 may transmit control signaling that configures the UE 115 for inter-slot PDCCH repetition. The control signaling may include one or more parameters for inter-slot PDCCH repetition, such as a repetition parameter or a repetition factor, R. The UE 115 may monitor for inter-slot PDCCH repetition in a scheduling window 405 according to a PDCCH monitoring pattern based on a configuration for the inter-slot PDCCH repetition.

The scheduling window 405 may include one or more sub-windows 410 based on a quantity of PDCCH monitoring occasions in the scheduling window 405, a quantity of actually transmitted SSBs (e.g., N), and the repetition parameter. For example, the scheduling window 405 may include eight sub-windows 410, including a sub-window 410-a and a sub-window 410-b. PDCCH monitoring occasions corresponding to the beams 415 may cycle through each sub-window 410 and may repeat across sub-windows 410. The inter-slot repetition configuration 400 shows an example of a second repetition pattern, including contiguous PDCCH repetition corresponding to associated SSBs.

In the example of FIG. 4, the network entity 105 may configure a repetition parameter of four, indicating four PDCCH repetitions associated with each SSB (e.g., each beam 415). In other examples, the network entity 105 may configure a different value for the repetition parameter. For the second repetition pattern, the UE 115 may monitor each [x×N+K]th PDCCH monitoring occasion for PDCCH repetitions, with x ranging from 0 to X−1 and K ranging from 1 to N.

For example, in sub-window 410-a, PDCCH associated with each beam corresponding to an actually transmitted SSB may be transmitted once, and in the sub-window 410-b, PDCCH associated with each beam corresponding to an actually transmitted SSB may be transmitted once, from a first beam (e.g., beam 415-a) to an N th beam (e.g., beam 415-c). A PDCCH associated with the beam 415-a in sub-window 410-b may carry a repetition of PDCCH associated with the beam 415-a in sub-window 410-a. For example, the UE 115 may monitor PDCCH monitoring occasions associated with a detected SSB in each sub-window to obtain the PDCCH repetitions. The UE 115 may determine that PDCCH is repeated across sub-windows with sub-window length of X/R. For example, the UE 115 may determine that PDCCH is repeated in sub-windows where {x=0,1, . . . R−1} or {x=R, R+1, . . . 2R−1}. For example, the UE 115 may determine that PDCCH is repeated in a first four sub-windows 410 of the scheduling window 405 or a last four sub-windows of the scheduling window 405 when the repetition parameter is set to four.

A UE 115 may monitor for PDCCH based on a detected SSB. For example, the UE 115 may detect an SSB corresponding to beam 415-b, and the UE 115 may monitor for repetitions of PDCCH in PDCCH monitoring occasions that correspond to beam 415-b. In some examples, RRC signaling, system information (e.g., an SIB), a MIB, or any combination thereof, may indicate the inter-slot PDCCH repetition configuration. The UE 115 may monitor PDCCH monitoring occasions for the PDCCH repetitions based on the inter-slot PDCCH repetition configuration.

In some examples, the second repetition pattern may be supported by UEs 115 which do not support PDCCH repetition. For example, at least part of a PDCCH occasion per beam may be identifiable by a UE 115 which does not support PDCCH repetition. In some examples, UEs which are capable of PDCCH repetition and UEs 115 which are not capable of PDCCH repetition may be configured with a scheduling window 420, and UEs 115 which are capable of PDCCH repetition may be configured with the repetition parameter R. A length of the scheduling window 405, for UEs 115 which are capable of inter-slot PDCCH repetition, may correspond to a length of the scheduling window 420 times R. For example, the scheduling window 420 may repeat R times in the scheduling window 405. A UE 115 which does not support PDCCH repetition may monitor for PDCCH in PDCCH monitoring occasions according to the scheduling window 420. In some other examples, the scheduling window 405 may be configured for UEs 115 which support PDCCH repetition (e.g., inter-slot PDCCH repetition), and the scheduling window 420 may be configured for UEs 115 which do not support PDCCH repetition (e.g., inter-slot PDCCH repetition) separately.

In some examples, the third repetition pattern may support DMRS bundling. For example, a UE 115 may use DMRS bundling for channel estimation or to combine PDCCH repetitions associated with a same beam 515 in a sub-window 510. For example, the network entity 105 may transmit the PDCCH repetitions in the sub-window 510 using a same beam and with coherent transmission, and the UE 115 may determine (e.g., assume) DMRS bundling is enabled for channel estimation.

In some examples, the network entity 105 may indicate how long a UE 115 may assume to use DMRS bundling for channel estimation. For example, the network entity 105 may configure a threshold delay, and the UE 115 may assume DMRS bundling for PDCCH repetitions that are received with a time difference that is within the threshold time delay. For example, the UE 115 may assume DMRS bundling when performing channel estimation for PDCCH repetitions that are received within a sub-window 510.

FIG. 5 shows an example of an inter-slot repetition configuration 500 that supports techniques for downlink control channel repetition in accordance with one or more aspects of the present disclosure. The inter-slot repetition configuration 500 may implement aspects of a wireless communications system 100 and a wireless communications system 200.

A network entity 105 may configure a UE 115 for inter-slot PDCCH repetition. For example, the network entity 105 may transmit control signaling that configures the UE 115 for inter-slot PDCCH repetition. The control signaling may include one or more parameters for inter-slot PDCCH repetition, such as a repetition parameter or a repetition factor, R. The UE 115 may monitor for inter-slot PDCCH repetition in a scheduling window 505 according to a PDCCH monitoring pattern based on a configuration for the inter-slot PDCCH repetition.

The scheduling window 505 may include one or more sub-windows 510 based on a quantity of PDCCH monitoring occasions in the scheduling window 505, a quantity of actually transmitted SSBs (e.g., N), and the repetition parameter. For example, the scheduling window 505 may include four sub-windows 510. PDCCH monitoring occasions corresponding to beams 515 of actually transmitted SSBs may have repetition within a sub-window 510 and be repeated across sub-windows 510. The inter-slot repetition configuration 500 shows an example of a third repetition pattern, including contiguous and non-contiguous PDCCH repetition corresponding to associated SSBs.

In the example of FIG. 5, the network entity 105 may configure a repetition parameter, R, of eight, indicating eight PDCCH repetitions. In other examples, the network entity 105 may configure a different value for the repetition parameter. In some examples, a UE 115 may be configured with a second repetition parameter, R1, corresponding to a quantity of contiguous PDCCH repetition. For example, each sub-window 510 may include two repetitions of PDCCH in contiguous slots associated with a same SSB (e.g., same beam 515). In some examples, the network entity 105 may configure a value for R1, such as through SIB1. In some other examples, a value for R1 may be statically configured or based on a value of R. A third repetition value, R2, may correspond to the quantity of sub-windows 510 in the scheduling window, or a quantity of times the contiguous PDCCH repetitions are repeated. For example, R2 may be equal to four, and the network entity 105 may transmit two PDCCH repetitions in contiguous slots four times in the scheduling window 505. For the third repetition pattern, the UE 115 may monitor each [x×R1×N+(K-1)×R1+r1] PDCCH monitoring occasion for PDCCH repetitions, with x ranging from 0 to X−1, K ranging from 1 to N, and r 1 ranging from 1 to R 1.

For example, in a sub-window 510, PDCCH repetitions may be transmitted in two contiguous slots for each beam corresponding to an actually transmitted SSB. In some examples, the sub-window 510 may repeat for the scheduling window 505. For example, a first two PDCCH monitoring occasions in a sub-window 510 may include two PDCCH repetitions transmitted using a beam 515-a, a next two (e.g., R1) PDCCH monitoring occasions in the sub-window 510 may include two PDCCH repetitions transmitted using a beam 515-b, and an Nth two PDCCH monitoring occasions in the sub-window may include two PDCCH repetitions transmitted using an Nth beam (e.g., beam 515-c).

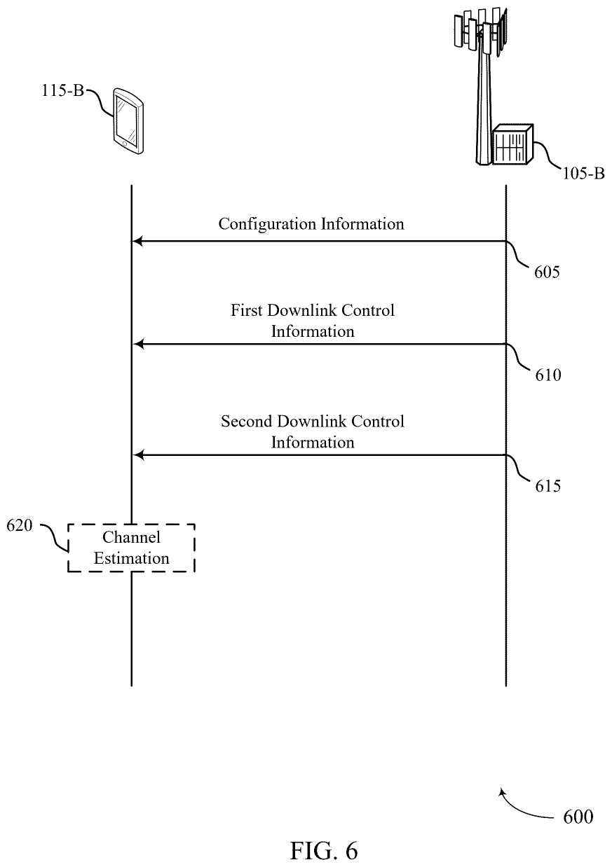

FIG. 6 shows an example of a process flow 600 that supports techniques for downlink control channel repetition in accordance with one or more aspects of the present disclosure. The process flow 600 may implement aspects of a wireless communications system 100, a wireless communications system 200, an inter-slot repetition configuration 300, an inter-slot repetition configuration 400, an inter-slot repetition configuration 500, or any combination thereof. For example, the process flow 600 may be implemented by a UE 115-b or a network entity 105-b, or both, which may be examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 600, some aspects of some operations may also be performed by one or more other wireless devices.

At 605, the network entity 105-b may transmit, and the UE 115-b may receive, configuration information associated with downlink control channel repetition. The configuration information may include a repetition parameter and a monitoring window duration. In some examples, the configuration information may be received via SIB1, a MIB, or RRC signaling, or any combination thereof. In some examples, the configuration information may include a first quantity of downlink control channel repetitions in occasions that are contiguous in time and a second quantity of downlink control channel repetitions in the monitoring window duration. In some examples, the configuration information includes a threshold duration associated with demodulation reference signal bundling. In some examples, the configuration information includes a threshold frequency gap associated with demodulation reference signal bundling.

At 610, the network entity 105-b may transmit, and the UE 115-b may receive, receive first downlink control information in a first occasion of a monitoring window with the monitoring window duration based on the configuration information. The first occasion of the monitoring window may be associated with a first SSB. In some examples, the downlink control channel repetition is inter-slot repetition, and an occasion may correspond to a slot. In some examples, the downlink control channel repetition is intra-slot repetition, and an occasion may correspond to a sub-slot. In some examples, the downlink control channel repetition may include aspects of intra-slot repetition and inter-slot repetition.

At 615, the network entity 105-b may transmit, and the UE 115-b may receive, second downlink control information that is a repetition of the first downlink control information in a second occasion of the monitoring window based on the configuration information and in accordance with the repetition parameter. The second occasion of the monitoring window may be associated with the first SSB.

In some examples, multiple occasions, including at least the first occasion and the second occasion, associated with the first SSB and corresponding to the repetition parameter are contiguous in time in the monitoring window. For example, the downlink control channel repetition may be configured according to a first repetition pattern as described with reference to FIG. 3. In some examples, the first occasion and the second occasion are non-contiguous in time based on a quantity of actually transmitted SSBs. For example, the downlink control channel repetition may be configured according to a second repetition pattern as described with reference to FIG. 4.

In some examples, the UE 115-b may perform channel estimation at 620. For example, the UE 115-b may estimate a downlink control channel for the first downlink control information or the second downlink control information, or both, based on a DMRS bundling for the first occasion and the second occasion. In some examples, the UE 115-b may perform the channel estimation for the first downlink control information and the second downlink control information (e.g., together) based on a delay between the first occasion and the second occasion satisfying the threshold duration. In some examples, the UE 115-b may perform the channel estimation for the first downlink control information and the second downlink control information (e.g., together) based on a frequency gap between the first occasion and the second occasion satisfying the threshold frequency gap.

In some examples, the UE 115-b may perform a first blind decoding procedure to obtain the first downlink control information based on first control channel candidates of the first occasion having a timing configuration. In some examples, the UE 115-b may perform a second blind decoding procedure to obtain the second downlink control information based on second control channel candidates of the second occasion having the timing configuration. In some examples, the UE 115-b may perform the second blind decoding procedure based on the first control channel candidates of the first occasion and the second control channel candidates of the second occasion. In some examples, the first blind decoding procedure and the second blind decoding procedure may be performed based on an aggregation level that is above a threshold in accordance with the downlink control channel repetition.

In some examples, the UE 115-b may operate in an inactive mode or an idle mode. For example, the UE 115-b may operate in an RRC idle mode or an RRC inactive mode. In some examples, the downlink control channel repetition may be associated with the inactive mode or the idle mode, or both. In some examples, the first downlink control information and the second downlink control information may include scheduling information for RMSI, paging information, multi-broadcast system information, paging early indication information, or any combination thereof.

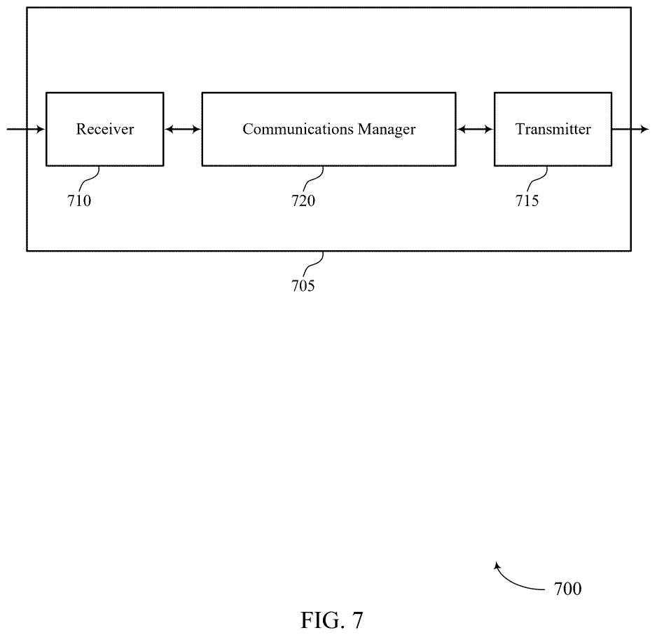

FIG. 7 shows a block diagram 700 of a device 705 that supports techniques for downlink control channel repetition in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for downlink control channel repetition). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for downlink control channel repetition). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for downlink control channel repetition as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving configuration information associated with downlink control channel repetition, where the configuration information includes a repetition parameter and a monitoring window duration. The communications manager 720 is capable of, configured to, or operable to support a means for receiving first downlink control information in a first occasion of a monitoring window with the monitoring window duration based on the configuration information, where the first occasion of the monitoring window is associated with a first synchronization signal block. The communications manager 720 is capable of, configured to, or operable to support a means for receiving second downlink control information that is a repetition of the first downlink control information in a second occasion of the monitoring window based on the configuration information and in accordance with the repetition parameter, where the second occasion of the monitoring window is associated with the first synchronization signal block.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing and reduced power consumption.

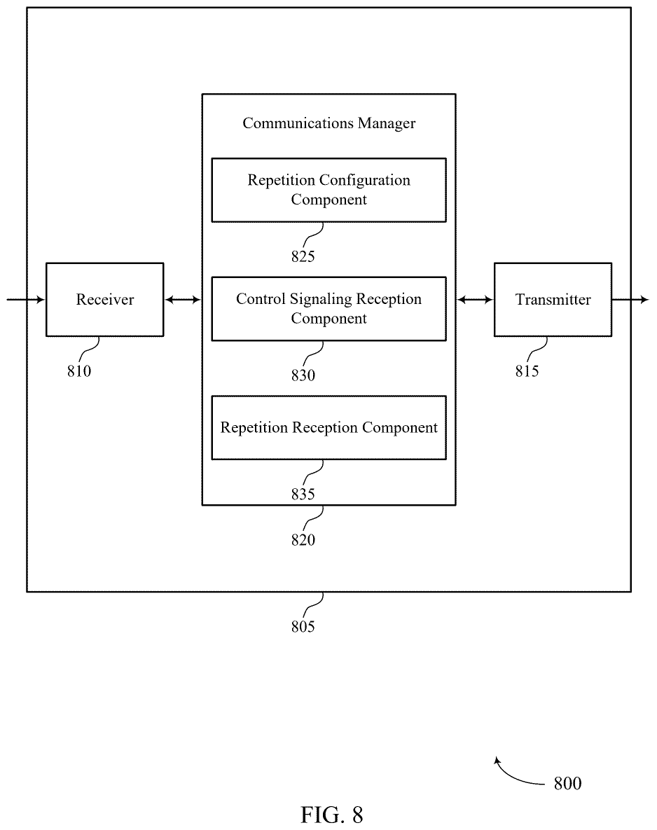

FIG. 8 shows a block diagram 800 of a device 805 that supports techniques for downlink control channel repetition in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for downlink control channel repetition). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for downlink control channel repetition). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for downlink control channel repetition as described herein. For example, the communications manager 820 may include a repetition configuration component 825, a control signaling reception component 830, a repetition reception component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The repetition configuration component 825 is capable of, configured to, or operable to support a means for receiving configuration information associated with downlink control channel repetition, where the configuration information includes a repetition parameter and a monitoring window duration. The control signaling reception component 830 is capable of, configured to, or operable to support a means for receiving first downlink control information in a first occasion of a monitoring window with the monitoring window duration based on the configuration information, where the first occasion of the monitoring window is associated with a first synchronization signal block. The repetition reception component 835 is capable of, configured to, or operable to support a means for receiving second downlink control information that is a repetition of the first downlink control information in a second occasion of the monitoring window based on the configuration information and in accordance with the repetition parameter, where the second occasion of the monitoring window is associated with the first synchronization signal block.

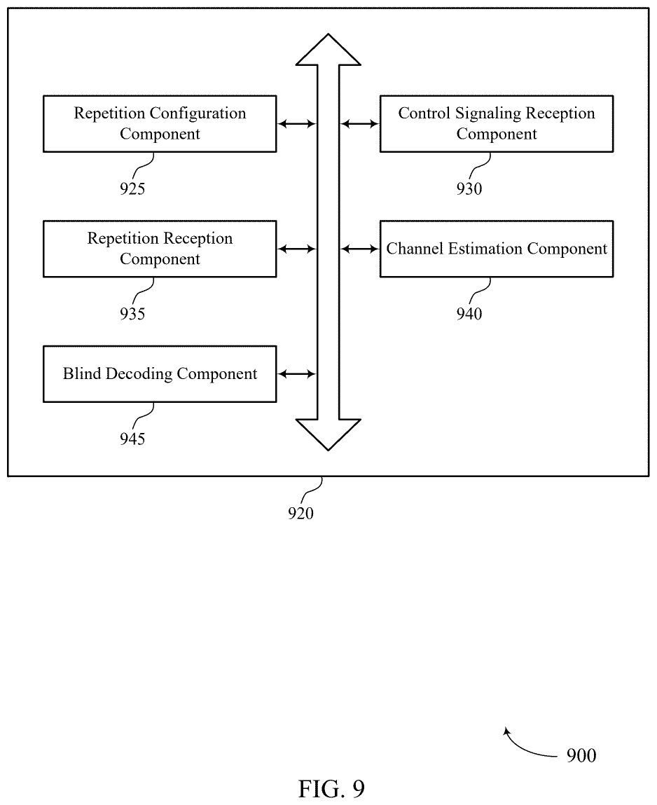

FIG. 9 shows a block diagram 900 of a communications manager 920 that supports techniques for downlink control channel repetition in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for downlink control channel repetition as described herein. For example, the communications manager 920 may include a repetition configuration component 925, a control signaling reception component 930, a repetition reception component 935, a channel estimation component 940, a blind decoding component 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The repetition configuration component 925 is capable of, configured to, or operable to support a means for receiving configuration information associated with downlink control channel repetition, where the configuration information includes a repetition parameter and a monitoring window duration. The control signaling reception component 930 is capable of, configured to, or operable to support a means for receiving first downlink control information in a first occasion of a monitoring window with the monitoring window duration based on the configuration information, where the first occasion of the monitoring window is associated with a first synchronization signal block. The repetition reception component 935 is capable of, configured to, or operable to support a means for receiving second downlink control information that is a repetition of the first downlink control information in a second occasion of the monitoring window based on the configuration information and in accordance with the repetition parameter, where the second occasion of the monitoring window is associated with the first synchronization signal block.

In some examples, the downlink control channel repetition is inter-slot repetition with an occasion corresponding to a slot, intra-slot repetition with an occasion corresponding to a sub-slot, or a combination of the inter-slot repetition and the intra-slot repetition.

In some examples, a set of multiple occasions, including at least the first occasion and the second occasion, associated with the first synchronization signal block and corresponding to the repetition parameter are contiguous in time in the monitoring window.

In some examples, the first occasion and the second occasion are non-contiguous in time based on a quantity of actually transmitted synchronization signals blocks.

In some examples, the monitoring window duration is based on the repetition parameter and a second monitoring window duration that is not associated with the downlink control channel repetition.

In some examples, the configuration information includes a first quantity of downlink control channel repetitions in occasions that are contiguous in time and a second quantity of downlink control channel repetitions in the monitoring window duration.

In some examples, the configuration information includes a pattern for the downlink control channel repetition including contiguous downlink control channel repetition or non-contiguous downlink control channel repetition.

In some examples, the channel estimation component 940 is capable of, configured to, or operable to support a means for estimating a downlink control channel for the first downlink control information or the second downlink control information, or both, based on a demodulation reference signal bundling for the first occasion and the second occasion.

In some examples, the configuration information includes a threshold duration associated with the demodulation reference signal bundling. In some examples, a delay between the first occasion and the second occasion satisfies the threshold duration.

In some examples, the configuration information includes a threshold frequency gap associated with the demodulation reference signal bundling. In some examples, a frequency gap between the first occasion and the second occasion satisfies the threshold frequency gap.

In some examples, the configuration information includes an indication that demodulation reference signal bundling is enabled for the downlink control channel repetition.

In some examples, the blind decoding component 945 is capable of, configured to, or operable to support a means for performing a first blind decoding procedure to obtain the first downlink control information based on first control channel candidates of the first occasion having a timing configuration. In some examples, the blind decoding component 945 is capable of, configured to, or operable to support a means for performing a second blind decoding procedure to obtain the second downlink control information based on second control channel candidates of the second occasion having the timing configuration.

In some examples, the first blind decoding procedure and the second blind decoding procedure are performed based on an aggregation level that is above a threshold in accordance with the downlink control channel repetition.

In some examples, the first downlink control information and the second downlink control information include a same slot offset value, a redundancy value associated with a first physical downlink shared channel, respective repetition parameters, or any combination thereof.

In some examples, the UE is operating in an inactive mode or an idle mode. In some examples, the downlink control channel repetition is associated with the inactive mode or the idle mode, or both.

In some examples, the first downlink control information and the second downlink control information include scheduling information for remaining minimum system information, paging information, multi-broadcast system information, paging early indication information, or any combination thereof.

In some examples, the UE is operating in a non-terrestrial network or using a radio frequency spectrum band of the non-terrestrial network.

In some examples, the first downlink control information and the second downlink control information are received via broadcast signaling, multi-cast signaling, or multi-broadcast signaling, or any combination thereof.

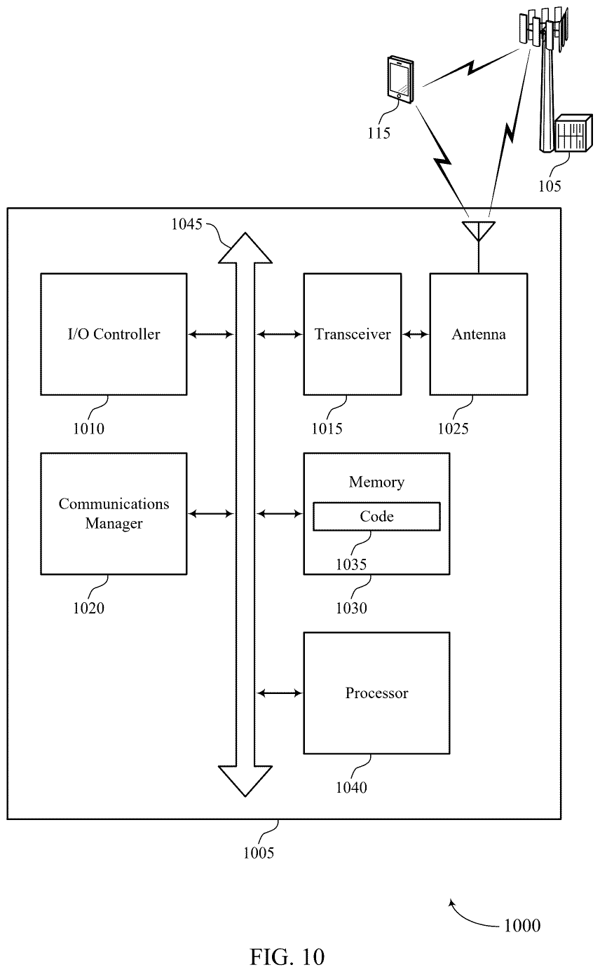

FIG. 10 shows a diagram of a system 1000 including a device 1005 that supports techniques for downlink control channel repetition in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for downlink control channel repetition). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving configuration information associated with downlink control channel repetition, where the configuration information includes a repetition parameter and a monitoring window duration. The communications manager 1020 is capable of, configured to, or operable to support a means for receiving first downlink control information in a first occasion of a monitoring window with the monitoring window duration based on the configuration information, where the first occasion of the monitoring window is associated with a first synchronization signal block. The communications manager 1020 is capable of, configured to, or operable to support a means for receiving second downlink control information that is a repetition of the first downlink control information in a second occasion of the monitoring window based on the configuration information and in accordance with the repetition parameter, where the second occasion of the monitoring window is associated with the first synchronization signal block.

By including or configuring the communications manager 1020 in accordance with examples as described herein, the device 1005 may support techniques for reduced power consumption, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for downlink control channel repetition as described herein, or the at least one processor 1040 and the at least one memory 1030 may be otherwise configured to, individually or collectively, perform or support such operations.

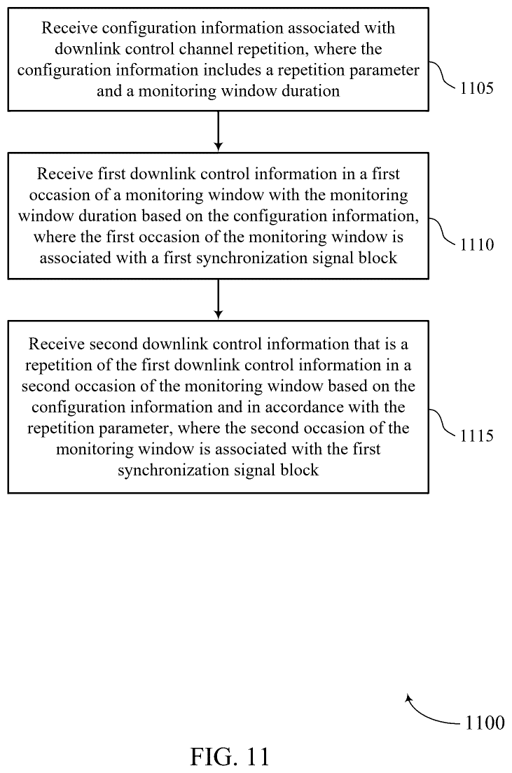

FIG. 11 shows a flowchart illustrating a method 1100 that supports techniques for downlink control channel repetition in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving configuration information associated with downlink control channel repetition, where the configuration information includes a repetition parameter and a monitoring window duration. The operations of 1105 may be performed in accordance with examples as disclosed herein. In some examples, aspects of the operations of 1105 may be performed by a repetition configuration component 925 as described with reference to FIG. 9.

At 1110, the method may include receiving first downlink control information in a first occasion of a monitoring window with the monitoring window duration based on the configuration information, where the first occasion of the monitoring window is associated with a first synchronization signal block. The operations of 1110 may be performed in accordance with examples as disclosed herein. In some examples, aspects of the operations of 1110 may be performed by a control signaling reception component 930 as described with reference to FIG. 9.

At 1115, the method may include receiving second downlink control information that is a repetition of the first downlink control information in a second occasion of the monitoring window based on the configuration information and in accordance with the repetition parameter, where the second occasion of the monitoring window is associated with the first synchronization signal block. The operations of 1115 may be performed in accordance with examples as disclosed herein. In some examples, aspects of the operations of 1115 may be performed by a repetition reception component 935 as described with reference to FIG. 9.

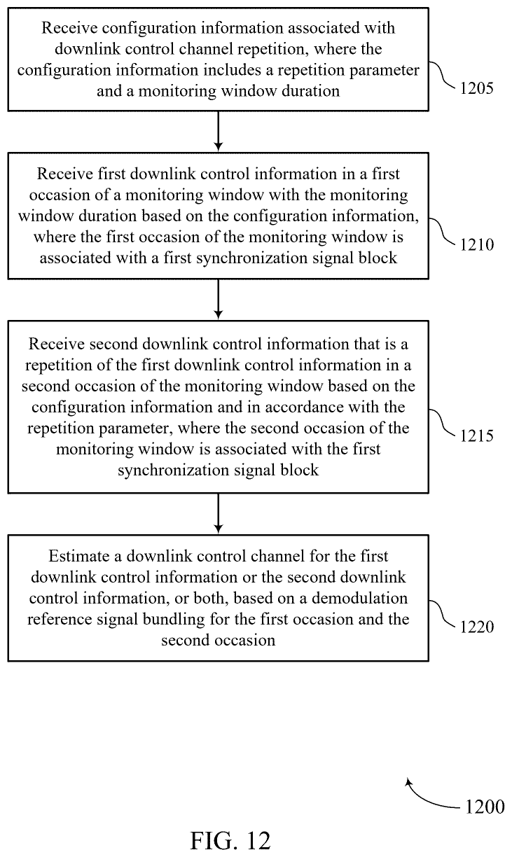

FIG. 12 shows a flowchart illustrating a method 1200 that supports techniques for downlink control channel repetition in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving configuration information associated with downlink control channel repetition, where the configuration information includes a repetition parameter and a monitoring window duration. The operations of 1205 may be performed in accordance with examples as disclosed herein. In some examples, aspects of the operations of 1205 may be performed by a repetition configuration component 925 as described with reference to FIG. 9.

At 1210, the method may include receiving first downlink control information in a first occasion of a monitoring window with the monitoring window duration based on the configuration information, where the first occasion of the monitoring window is associated with a first synchronization signal block. The operations of 1210 may be performed in accordance with examples as disclosed herein. In some examples, aspects of the operations of 1210 may be performed by a control signaling reception component 930 as described with reference to FIG. 9.

At 1215, the method may include receiving second downlink control information that is a repetition of the first downlink control information in a second occasion of the monitoring window based on the configuration information and in accordance with the repetition parameter, where the second occasion of the monitoring window is associated with the first synchronization signal block. The operations of 1215 may be performed in accordance with examples as disclosed herein. In some examples, aspects of the operations of 1215 may be performed by a repetition reception component 935 as described with reference to FIG. 9.

At 1220, the method may include estimating a downlink control channel for the first downlink control information or the second downlink control information, or both, based on a demodulation reference signal bundling for the first occasion and the second occasion. The operations of 1220 may be performed in accordance with examples as disclosed herein. In some examples, aspects of the operations of 1220 may be performed by a channel estimation component 940 as described with reference to FIG. 9.

The following provides an overview of aspects of the present disclosure:
Aspect 1: A method for wireless communications at a UE, comprising:
   receiving configuration information associated with downlink control channel repetition, wherein the configuration information comprises a repetition parameter and a monitoring window duration; receiving first downlink control information in a first occasion of a monitoring window with the monitoring window duration based at least in part on the configuration information, wherein the first occasion of the monitoring window is associated with a first synchronization signal block; and receiving second downlink control information that is a repetition of the first downlink control information in a second occasion of the monitoring window based at least in part on the configuration information and in accordance with the repetition parameter, wherein the second occasion of the monitoring window is associated with the first synchronization signal block.
   Aspect 2: The method of aspect 1, wherein the downlink control channel repetition is inter-slot repetition with an occasion corresponding to a slot, intra-slot repetition with an occasion corresponding to a sub-slot, or a combination of the inter-slot repetition and the intra-slot repetition.
   Aspect 3: The method of any of aspects 1 through 2, wherein a plurality of occasions, comprising at least the first occasion and the second occasion, associated with the first synchronization signal block and corresponding to the repetition parameter are contiguous in time in the monitoring window.
   Aspect 4: The method of any of aspects 1 through 3, wherein the first occasion and the second occasion are non-contiguous in time based at least in part on a quantity of actually transmitted synchronization signals blocks.
   Aspect 5: The method of any of aspects 1 through 4, wherein the monitoring window duration is based at least in part on the repetition parameter and a second monitoring window duration that is not associated with the downlink control channel repetition.
   Aspect 6: The method of any of aspects 1 through 5, wherein the configuration information includes a first quantity of downlink control channel repetitions in occasions that are contiguous in time and a second quantity of downlink control channel repetitions in the monitoring window duration.
   Aspect 7: The method of any of aspects 1 through 6, wherein the configuration information includes a pattern for the downlink control channel repetition comprising contiguous downlink control channel repetition or non-contiguous downlink control channel repetition.
   Aspect 8: The method of any of aspects 1 through 7, further comprising: estimating a downlink control channel for the first downlink control information or the second downlink control information, or both, based at least in part on a demodulation reference signal bundling for the first occasion and the second occasion.
   Aspect 9: The method of aspect 8, wherein the configuration information includes a threshold duration associated with the demodulation reference signal bundling, and a delay between the first occasion and the second occasion satisfies the threshold duration.
   Aspect 10: The method of any of aspects 8 through 9, wherein the configuration information includes a threshold frequency gap associated with the demodulation reference signal bundling, and a frequency gap between the first occasion and the second occasion satisfies the threshold frequency gap.
   Aspect 11: The method of any of aspects 8 through 10, wherein the configuration information includes an indication that demodulation reference signal bundling is enabled for the downlink control channel repetition.
   Aspect 12: The method of any of aspects 1 through 11, further comprising: performing a first blind decoding procedure to obtain the first downlink control information based at least in part on first control channel candidates of the first occasion having a timing configuration; and performing a second blind decoding procedure to obtain the second downlink control information based at least in part on second control channel candidates of the second occasion having the timing configuration.
   Aspect 13: The method of aspect 12, wherein the first blind decoding procedure and the second blind decoding procedure are performed based at least in part on an aggregation level that is above a threshold in accordance with the downlink control channel repetition.
   Aspect 14: The method of any of aspects 1 through 13, wherein the first downlink control information and the second downlink control information comprise a same slot offset value, a redundancy value associated with a first physical downlink shared channel, respective repetition parameters, or any combination thereof.
   Aspect 15: The method of any of aspects 1 through 14, wherein the UE is operating in an inactive mode or an idle mode, and the downlink control channel repetition is associated with the inactive mode or the idle mode, or both.
   Aspect 16: The method of any of aspects 1 through 15, wherein the first downlink control information and the second downlink control information comprise scheduling information for remaining minimum system information, paging information, multi-broadcast system information, paging early indication information, or any combination thereof.
   Aspect 17: The method of any of aspects 1 through 16, wherein the UE is operating in a non-terrestrial network or using a radio frequency spectrum band of the non-terrestrial network.
   Aspect 18: The method of any of aspects 1 through 17, wherein the first downlink control information and the second downlink control information are received via broadcast signaling, multi-cast signaling, or multi-broadcast signaling, or any combination thereof.
   Aspect 19: A UE for wireless communications, comprising one or more memories storing processor-executable code, and one or more processors coupled with the one or more memories and individually or collectively operable to execute the code to cause the UE to perform a method of any of aspects 1 through 18.
   Aspect 20: A UE for wireless communications, comprising at least one means for performing a method of any of aspects 1 through 18.
   Aspect 21: A non-transitory computer-readable medium storing code for wireless communications, the code comprising instructions executable by one or more processors to perform a method of any of aspects 1 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information associated with downlink control channel repetition, wherein the configuration information comprises a repetition parameter and a monitoring window duration;
receive first downlink control information in a first occasion of a monitoring window with the monitoring window duration based at least in part on the configuration information, wherein the first occasion of the monitoring window is associated with a first synchronization signal block; and
receive second downlink control information that is a repetition of the first downlink control information in a second occasion of the monitoring window based at least in part on the configuration information and in accordance with the repetition parameter, wherein the second occasion of the monitoring window is associated with the first synchronization signal block.

2. The UE of claim 1, wherein the downlink control channel repetition is inter-slot repetition with an occasion corresponding to a slot, intra-slot repetition with an occasion corresponding to a sub-slot, or a combination of the inter-slot repetition and the intra-slot repetition.

3. The UE of claim 1, wherein a plurality of occasions, comprising at least the first occasion and the second occasion, associated with the first synchronization signal block and corresponding to the repetition parameter are contiguous in time in the monitoring window.

4. The UE of claim 1, wherein the first occasion and the second occasion are non-contiguous in time based at least in part on a quantity of actually transmitted synchronization signals blocks.

5. The UE of claim 1, wherein the monitoring window duration is based at least in part on the repetition parameter and a second monitoring window duration that is not associated with the downlink control channel repetition.

6. The UE of claim 1, wherein the configuration information includes a first quantity of downlink control channel repetitions in occasions that are contiguous in time and a second quantity of downlink control channel repetitions in the monitoring window duration.

7. The UE of claim 1, wherein the configuration information includes a pattern for the downlink control channel repetition comprising contiguous downlink control channel repetition or non-contiguous downlink control channel repetition.

8. The UE of claim 1, wherein the one or more processors are individually or collectively further operable to execute the code to cause the UE to:
estimate a downlink control channel for the first downlink control information or the second downlink control information, or both, based at least in part on a demodulation reference signal bundling for the first occasion and the second occasion.

9. The UE of claim 8, wherein:
the configuration information includes a threshold duration associated with the demodulation reference signal bundling, and
a delay between the first occasion and the second occasion satisfies the threshold duration.

10. The UE of claim 8, wherein:
the configuration information includes a threshold frequency gap associated with the demodulation reference signal bundling, and
a frequency gap between the first occasion and the second occasion satisfies the threshold frequency gap.

11. The UE of claim 8, wherein the configuration information includes an indication that demodulation reference signal bundling is enabled for the downlink control channel repetition.

12. The UE of claim 1, wherein the one or more processors are individually or collectively further operable to execute the code to cause the UE to:
perform a first blind decoding procedure to obtain the first downlink control information based at least in part on first control channel candidates of the first occasion having a timing configuration; and
perform a second blind decoding procedure to obtain the second downlink control information based at least in part on second control channel candidates of the second occasion having the timing configuration.

13. The UE of claim 12, wherein the first blind decoding procedure and the second blind decoding procedure are performed based at least in part on an aggregation level that is above a threshold in accordance with the downlink control channel repetition.

14. The UE of claim 1, wherein the first downlink control information and the second downlink control information comprise a same slot offset value, a redundancy value associated with a first physical downlink shared channel, respective repetition parameters, or any combination thereof.

15. The UE of claim 1, wherein:
the UE is operating in an inactive mode or an idle mode, and
the downlink control channel repetition is associated with the inactive mode or the idle mode, or both.

16. The UE of claim 1, wherein the first downlink control information and the second downlink control information comprise scheduling information for remaining minimum system information, paging information, multi-broadcast system information, paging early indication information, or any combination thereof.

17. The UE of claim 1, wherein the UE is operating in a non-terrestrial network or using a radio frequency spectrum band of the non-terrestrial network.

18. The UE of claim 1, wherein the first downlink control information and the second downlink control information are received via broadcast signaling, multi-cast signaling, or multi-broadcast signaling, or any combination thereof.

19. A method for wireless communications at a user equipment (UE), comprising:
receiving configuration information associated with downlink control channel repetition, wherein the configuration information comprises a repetition parameter and a monitoring window duration;
receiving first downlink control information in a first occasion of a monitoring window with the monitoring window duration based at least in part on the configuration information, wherein the first occasion of the monitoring window is associated with a first synchronization signal block; and
receiving second downlink control information that is a repetition of the first downlink control information in a second occasion of the monitoring window based at least in part on the configuration information and in accordance with the repetition parameter, wherein the second occasion of the monitoring window is associated with the first synchronization signal block.

20. A non-transitory computer-readable medium storing code for wireless communications, the code comprising instructions executable by one or more processors to:
receive configuration information associated with downlink control channel repetition, wherein the configuration information comprises a repetition parameter and a monitoring window duration;
receive first downlink control information in a first occasion of a monitoring window with the monitoring window duration based at least in part on the configuration information, wherein the first occasion of the monitoring window is associated with a first synchronization signal block; and
receive second downlink control information that is a repetition of the first downlink control information in a second occasion of the monitoring window based at least in part on the configuration information and in accordance with the repetition parameter, wherein the second occasion of the monitoring window is associated with the first synchronization signal block.
